(19) United States
(12) Patent Application Publication
(10) Pub. No.: US 2011/0003208 A1
(43) Pub. Date: Jan. 6, 2011

(54) NEGATIVE ELECTRODE FOR NON-AQUEOUS ELECTROLYTE SECONDARY BATTERY AND NON-AQUEOUS ELECTROLYTE SECONDARY BATTERY

(76) Inventors: Tatsuki HIRAOKA, Osaka (JP); Masaya Ugaji, Osaka (JP); Taisuke Yamamoto, Nara (JP); Hideharu Takezawa, Nara (JP)

Correspondence Address: MCDERMOTT WILL & EMERY LLP, 600 13TH STREET, NW, WASHINGTON, DC, 20005-3096, US

(21) Appl. No.: 12/829,800

(22) Filed: Jul. 2, 2010

(30) Foreign Application Priority Data
Jul. 3, 2009 (JP) 2009-158589

(51) Int. Cl. H01M 4/58

(52) U.S. Cl. 429/231.95; 429/218.1

(57) ABSTRACT

A negative electrode for a non-aqueous electrolyte secondary battery including: a current collector; and an active material layer including at least two alloy-based active materials selected from the group consisting of silicon, tin, a silicon oxide, and a tin oxide. The active material layer includes a first portion supported on a surface of the current collector, a second portion supported on a surface of the first portion, and a third portion supported on a surface of the second portion. The first portion includes the silicon oxide or the tin oxide, and the oxygen content in the silicon oxide or the tin oxide in the first portion decreases continuously or stepwise as approaching the second portion. The second portion includes silicon or tin. The third portion includes the silicon oxide or the tin oxide, and the oxygen content in the silicon oxide or the tin oxide in the third portion increases continuously or stepwise with distance from the second portion.

### FIELD OF THE INVENTION

The present invention relates to a negative electrode for a non-aqueous electrolyte secondary battery and a non-aqueous electrolyte secondary battery. More specifically, the present invention mainly relates to an improvement of a negative electrode in a non-aqueous electrolyte secondary battery using an alloy-based active material.

### BACKGROUND OF THE INVENTION

Non-aqueous electrolyte secondary batteries have a high capacity and a high energy density and can be easily reduced in size and weight, and for this reason, have been widely used as power sources for electronic devices. Various studies have been made for using such non-aqueous electrolyte secondary batteries as power sources for transportation equipment such as electric vehicles, and some of them are being put into practical use. A typical non-aqueous electrolyte secondary battery includes a positive electrode containing a lithium-cobalt composite oxide, a negative electrode containing graphite, and a polyolefin porous film (separator).

Another known negative electrode active material other than graphite is an alloy-based active material. Examples of the alloy-based active material include silicon, tin, silicon oxides, and tin oxides. The alloy-based active material has a high capacity. For example, the theoretical discharge capacity of silicon is about 4199 mAh/g, which is about 11 times as large as the theoretical discharge capacity of graphite.

Non-aqueous electrolyte secondary batteries using such an alloy-based active material have an excellent battery performance; however, when the batteries are subjected to a large number of charge/discharge cycles, problems such as a drastic deterioration in cycle characteristics and a deformation of the battery tend to occur. The occurrence of such problems is considered to be resulted from the changes in volume of the alloy-based active material. The alloy-based active material undergoes significant changes in volume (expansion and contraction) as lithium ions are absorbed thereto and desorbed therefrom during charge/discharge cycles, and generates relatively large stresses as a result of such changes in volume.

Japanese Laid-Open Patent Publication No. 2008-192594 (hereinafter referred to as “Patent Document 1”) discloses a negative electrode for a non-aqueous electrolyte secondary battery including a current collector having a plurality of protrusions on its surface, and columns comprising an alloy-based active material and being formed on the surfaces of the protrusions. Each column has in its interior a region where the changes in volume associated with absorption and desorption of lithium ions are small, and thus the separation of the column from the surface of the protrusion, and the like can be prevented.

Japanese Laid-Open Patent Publication No. 2007-257868 (hereinafter referred to as “Patent Document 2”) discloses a negative electrode for a non-aqueous electrolyte secondary battery including: a current collector; and an active material layer containing silicon and a metal element such as Ti, Cr, Fe, Co, Ni and Zr and including a metal element increase/decrease region where the content of the metal element increases and then decreases in the thickness direction of the active material layer.

### BRIEF SUMMARY OF THE INVENTION

The present invention intends to provide a non-aqueous electrolyte secondary battery using an alloy-based active material as a negative electrode active material, the non-aqueous electrolyte secondary battery being excellent in cycle characteristics and rate characteristics and capable of preventing the deterioration in cycle characteristics and the swelling of the battery even when the number of charge/discharge cycles is increased.

A negative electrode for a non-aqueous electrolyte secondary battery of the present invention includes: a current collector; and an active material layer being supported on the current collector and comprising at least two alloy-based active materials selected from the group consisting of silicon, tin, a silicon oxide, and a tin oxide, wherein: the active material layer includes a first portion supported on a surface of the current collector, a second portion supported on a surface of the first portion, and a third portion supported on a surface of the second portion; the first portion includes the silicon oxide or the tin oxide, and an oxygen content in the silicon oxide or the tin oxide in the first portion decreases continuously or stepwise as approaching the second portion; the second portion includes silicon or tin; and the third portion includes the silicon oxide or the tin oxide, and an oxygen content in the silicon oxide or the tin oxide in the third portion increases continuously or stepwise with distance from the second portion.

A non-aqueous electrolyte secondary battery of the present invention includes a positive electrode capable of absorbing and desorbing lithium ions, a negative electrode capable of absorbing and desorbing lithium ions, a separator interposed between the positive electrode and the negative electrode, and a non-aqueous electrolyte, wherein the negative electrode is the above-described negative electrode for a non-aqueous electrolyte secondary battery.

The non-aqueous electrolyte secondary battery of the present invention, because of the inclusion of an alloy-based active material, is high in capacity, energy density and output power, and further is excellent in battery performance such as rate characteristics and cycle characteristics. Further, the non-aqueous electrolyte secondary battery of the present invention shows little deterioration in cycle characteristics, little swelling of the battery and the like even when the number of charge/discharge cycle is increased.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal cross-sectional view schematically showing the configuration of a non-aqueous electrolyte secondary battery according to a first embodiment of the present invention.

FIG. 2 is a top view schematically showing the configuration of a negative electrode current collector included in the non-aqueous electrolyte secondary battery shown in FIG. 1.

FIG. 3 is a longitudinal cross-sectional view schematically showing the configuration of a negative electrode according to a second embodiment of the present invention.

FIG. 4 is a longitudinal cross-sectional view schematically showing the configuration of a column included in a negative electrode active material layer of the negative electrode shown in FIG. 3.

FIG. 5 is a longitudinal cross-sectional view for explaining a production method of the column shown in FIG. 4.

FIG. 6 is a set of longitudinal cross-sectional views for explaining a production method of a negative electrode current collector.

FIG. 7 is a top view schematically showing a configuration of an essential part of a negative electrode current collector.

FIG. 8 is a side perspective view schematically showing the configuration of an electron beam vacuum vapor deposition apparatus.

### DETAILED DESCRIPTION OF THE INVENTION

The present inventors have directed their attention to Patent Document 1 through the course of studies for achieving the above-described purpose. A non-aqueous electrolyte secondary battery including the negative electrode disclosed in Patent Document 1 is high in output power and capacity, and is excellent in cycle characteristics and shows little deterioration in cycle characteristics, little swelling of the battery, and the like. The present inventors have noted, however, that even in the foregoing non-aqueous electrolyte secondary battery, there is a possibility that the deterioration in cycle characteristics, the swelling of the battery, and the like occur with the increase in the number of charge/discharge cycles.

The present inventors have examined the reason why the deterioration in cycle characteristics, the swelling of the battery, and the like occur with the increase in the number of charge/discharge cycles in the non-aqueous electrolyte secondary battery including the negative electrode disclosed in Patent Document 1, and as a result, obtained the following findings.

In the negative electrode disclosed in Patent Document 1, the columns forming the negative electrode active material layer are each configured to include a SiOₓ layer having a relatively low oxygen content as a matrix and further include another SiOₓ layer having a relatively high oxygen content as a region where the changes in volume associated with the absorption and desorption of lithium ions are smaller than those in the matrix. The volume of such a column is smaller than that of a column composed only of a SiOₓ layer having a relatively low oxygen content. At the beginning of charging, the volume of such a column is smallest since the column is in a lithium-ion desorbed state.

As such, part of the surface of the negative electrode current collector serves as an exposed area that directly faces the positive electrode. If charging is started in such a state, lithium ions released from the positive electrode will deposit as lithium metal on the exposed area of the surface of the negative electrode current collector. Consequently, the amount of lithium ions that can contribute to charging and discharging is decreased. This is presumably one of the causes of the deterioration in the cycle characteristics with the increase in the number of charge/discharge cycles.

Moreover, in the column of Patent Document 1, the SiOₓ layer having a relatively high oxygen content is in contact with the SiOₓ layer having a relatively low oxygen content. The difference in stresses generated in association with the changes in volume between these two SiOₓ layers is large, and the directions in which the stresses act are different. Since the stresses are generated in different directions while these two SiOₓ layers are in contact with each other, it is difficult to sufficiently reduce the stresses generated inside the column.

Because of this, with the increase in the number of charge/discharge cycles, a crack tends to easily occur at the interface between the SiOₓ layer having a relatively high oxygen content and the SiOₓ layer having a relatively low oxygen content. Further, a crack tends to easily occur also at the surface of the column. At the portion where the crack has occurred, a chemically active SiOₓ surface is exposed and comes in contact with the non-aqueous electrolyte, causing a side reaction. The side reaction thus caused consumes the non-aqueous electrolyte and SiOₓ and generates gas. This is presumably one of the causes of the deterioration in the cycle characteristics of the battery, the swelling of the battery, and the like.

Patent Document 2 intends to reduce the changes in volume of the negative electrode active material layer, and prevent the deformation of the negative electrode and the swelling of the battery, and the like, by adding a metal element that will not be involved in the absorption and desorption of lithium ions at a negative electrode potential to a negative electrode active material layer composed of silicon. However, it is very difficult, on an industrial scale, to uniformly disperse a desired amount of metal element in a matrix composed of silicon. For this reason, the negative electrode active material layer tends to include a region A where the content of the metal element is high and the changes in volume are relatively small, and a region B where the content of the metal element is low and the changes in volume are relatively large, the regions A and B being unevenly distributed.

The magnitudes of stresses generated in association with the changes in volume and the directions in which the stresses act in the region A are different from those in the region B. As such, the generated stresses are not sufficiently reduced at the interface between the region A and the region B, and a crack tends to easily occur at the interface. A crack tends to easily occur also at a surface of the negative electrode active material layer in the vicinity of the interface between the region A and the region B. As a result, a chemically active surface is exposed, causing a side reaction with the non-aqueous electrolyte. Therefore, also in the case of employing the negative electrode disclosed in Patent Document 2, it is considered impossible to sufficiently prevent the deterioration in the cycle characteristics, the swelling of the battery, and the like that occur with the increase in the number of charge/discharge cycles.

Based on the foregoing findings, the present inventors have conducted further studies. As a result, the present inventors have conceived of a configuration in which the negative electrode active material layer including an alloy-based active material is formed as a stack including of a first portion, a second portion, and a third portion. In the first portion, the oxygen content is decreased continuously or stepwise in the thickness direction thereof; in the second portion, the oxygen content is set lower than those in the first portion and the third portion; and in the third portion, the oxygen content is increased continuously or stepwise in the thickness direction thereof.

The present inventors have found that by employing the above configuration, the stresses generated inside the column are reduced, and the occurrence of a crack at the surface or in the interior of the column is prevented. The present inventors have further found that by adjusting the oxygen content in a region of the first portion in contact with the negative electrode current collector to be relatively high to minimize the changes in volume in the region, it is possible to prevent the surface of the negative electrode current collector from getting exposed to the positive electrode, and as a result, it is possible to prevent lithium ions from depositing as lithium metal on the surface of the negative electrode current collector during charging. The present inventors have further found that by employing the above configuration, it is possible not only to prevent the deterioration in the cycle characteristics, the swelling of the battery, but also to improve the rate characteristics.

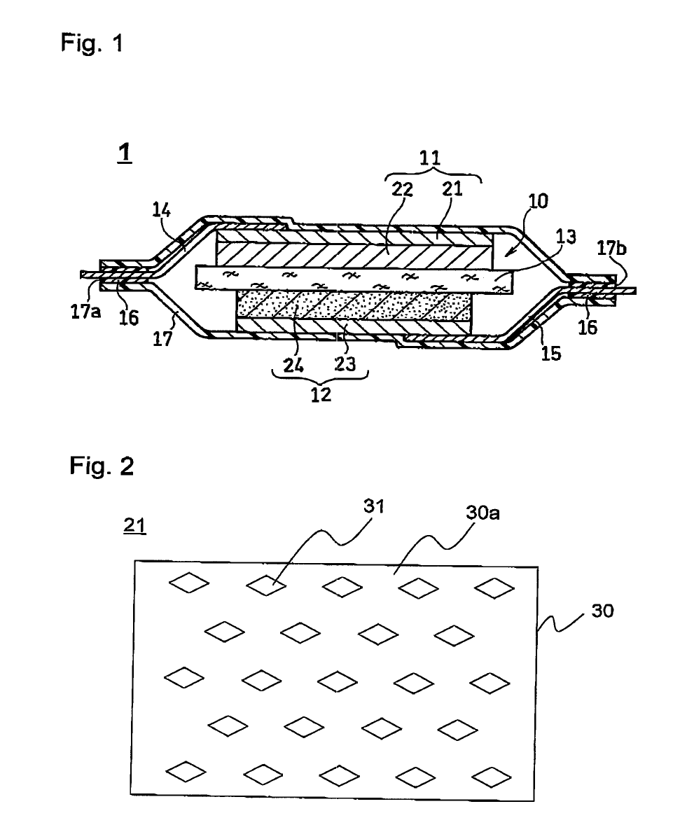

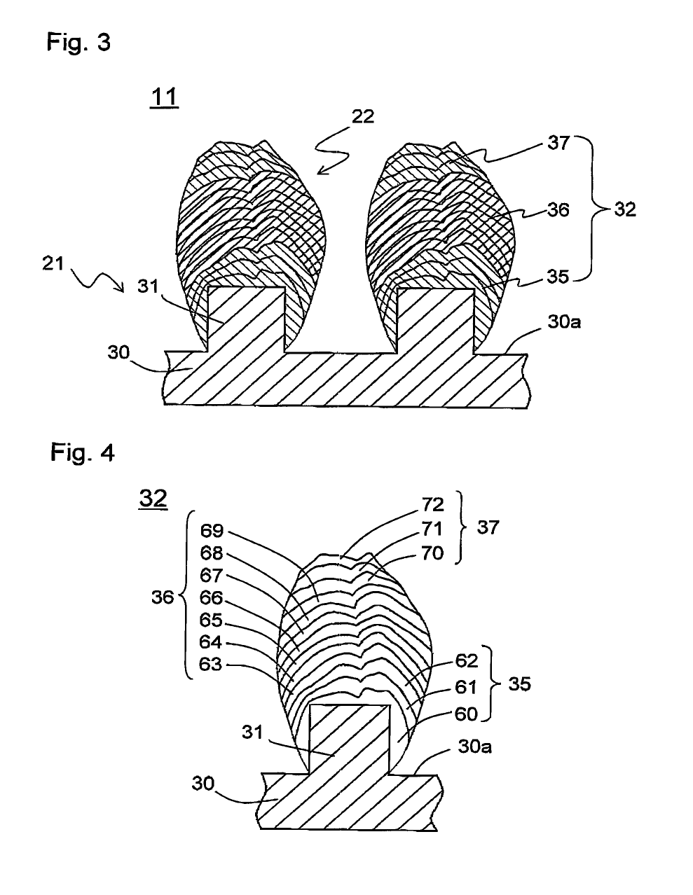

FIG. 1 is a longitudinal cross-sectional view schematically showing the configuration of a non-aqueous electrolyte secondary battery 1 according to a first embodiment of the present invention. FIG. 2 is a top view schematically showing the configuration of a negative electrode current collector 21 provided in the non-aqueous electrolyte secondary battery 1 shown in FIG. 1. FIG. 3 is a longitudinal cross-sectional view schematically showing the configuration of a negative electrode 11 according to a second embodiment of the present invention. FIG. 4 is a longitudinal cross-sectional view schematically showing the configuration of a column 32 included in a negative electrode active material layer 22 of the negative electrode 11 shown in FIG. 3.

The non-aqueous electrolyte secondary battery 1 includes: a stacked electrode assembly 10 formed by stacking the negative electrode 11 and a positive electrode 12 with a separator 13 interposed therebetween; a negative electrode lead 14 one end of which is connected to the negative electrode current collector 21, and the other end of which is extended out of a battery case 17 through an opening 17a thereof; a positive electrode lead 15 one end of which is connected to a positive electrode current collector 23, and the other end of which is extended out of the battery case 17 from an opening 17b thereof; gaskets 16 respectively welded to the openings 17a and 17b of the battery case 17 to seal the battery case 17; and the battery case 17 accommodating the electrode assembly 10 and a non-aqueous electrolyte (not shown). Each of the openings 17a and 17b may be directly welded without using the gaskets 16.

The negative electrode 11 includes the negative electrode current collector 21 and the negative electrode active material layer 22. The negative electrode 11 is characterized in that: the negative electrode current collector 21 has a plurality of protrusions 31 on the surface thereof; and the negative electrode active material layer 22 is composed of a plurality of the columns 32 each supported on each protrusion 31, the columns 32 each including of a first portion 35 supported on the surface of the protrusion 31, a second portion 36 supported on the surface of the first portion 35, and a third portion 37 supported on the surface of the second portion 36.

The negative electrode current collector 21 includes a sheet portion 30 and a plurality of the protrusions 31 as shown in FIG. 2. The negative electrode current collector 21 is made of a metal material such as stainless steel, titanium, nickel, copper, and a copper alloy. The thickness of the sheet portion 30 is not limited in particular, but is preferably 1 μm to 50 μm.

The protrusions 31 are formed so as to extend outward from a surface 30a of the seat portion 30 (hereinafter referred to as a “surface 30a”) and spaced apart from one another. A gap is present between a pair of columns 31 adjacent to each other. The protrusions 31 are arranged on the surface 30a in a staggered pattern in this embodiment, but not limited thereto, and may be arranged regularly, for example, in a grid pattern and or in a close-packed pattern, or may be arranged irregularly.

The protrusion 31 has an almost flat top surface at its tip end in the extending direction thereof. The flat top surface of the protrusion 31 is substantially parallel to the surface 30a. The tip end of the protrusion 31 is flat in this embodiment, but not limited thereto, and may be acute, for example, in a dome shape. The protrusion 31 may have one or two or more projections (not shown) on its surface.

The average height of the protrusions 31 is preferably 3 μm to 20 μm. The average width of the protrusions 31 is preferably 1 μm to 50 μm. The average height and the average width of the protrusions 31 are each determined by observing a cross section of the negative electrode under a scanning electron microscope to measure the heights and widths of one hundred protrusions 31, and averaging the measured values. The height of protrusion 31 is the length of a perpendicular line drawn from the uppermost end of the protrusion 31 to the surface 30a, on the cross section of the negative electrode. The width of protrusion 31 is the longest length of the protrusion 31 in the direction parallel to the surface 30a, on the cross section of the negative electrode. The cross section of the negative electrode is a cross section of the negative electrode 11 in the thickness direction thereof including the uppermost end of the protrusion 31.

The shape of the protrusion 31 is a rhomboid in this embodiment, but not limited thereto, and may be, for example, a circle, a polygon, an ellipse, a parallelogram, a trapezoid, and the like. The shape of the protrusion 31 is a shape of the protrusion 31 on an orthographic view thereof viewed from vertically above while the surface 30a is aligned with the horizontal plane.

The number of the protrusions 31 and the pitch (axis-to-axis distance) between the protrusions 31 are not particularly limited, and may be set according to the sizes and the like of the protrusion 31 and the column 32. The number of the protrusions 31 is preferably 10,000/cm² to 10,000,000/cm². The pitch between the protrusions 31 is preferably 2 μm to 100 μm. When the negative electrode current collector 21 is belt-shaped, the pitch between the protrusions 31 in the width direction thereof is preferably 4 μm to 30 μm, and the pitch between the protrusions 31 in the length direction thereof is preferably 4 μm to 40 μm.

When the shape of the protrusion 31 is a circle, the axis of the protrusion 31 is a straight line normal to the surface 30a passing through the center of the circle. When the shape of the protrusion 31 is a polygon, a parallelogram, a trapezoid, a rhomboid, or an ellipse, the axis of the protrusion 31 is a straight line normal to the surface 30a passing through the point of intersection of the diagonals or the point of intersection of the long and short axes.

The negative electrode current collector 21 is formed by, for example, a roller method. The roller method is a method of press-molding a metal sheet using a roller having depressions formed on its surface (hereinafter referred to as a “protrusion-forming roller”).

Specifically, a protrusion-forming roller and a roller with smooth surface are press-fitted with the axes of the two rollers being arranged parallel to each other so that a press fit portion is formed therebetween. By passing a metal sheet through the press fit portion, the negative electrode current collector 21 having the protrusions 31 which substantially correspond to the size and shape of the internal spaces of depressions formed on the surface of the protrusion-forming roller and to the number and arrangement of the depressions is produced. When two protrusion-forming rollers are press-fitted with the axes of the two rollers being arranged parallel to each other so that a press fit portion is formed therebetween, and a metal sheet is passed through the press fit portion, a negative electrode current collector having protrusions formed on both surfaces thereof in its thickness direction is produced.

The press fitting pressure of the rollers is appropriately selected according to the material and thickness of the metal sheet, the shape and size of the protrusions 31, the setting value of the thickness of the negative electrode current collector 21 (the sheet portion 30) to be obtained after press-molding, and the like.

Examples of the metal sheet include metal foil, metal film, and metal plate. The metal sheet is made of, for example, stainless steel, nickel, copper, or a copper alloy. The surface of the metal sheet may be roughened by plating, etching, sandblasting, and the like, prior to the formation of the protrusions 31. When the protrusions 31 are formed on a metal sheet with roughed surface by a roller method, the surface roughness of the roughened surface of the metal sheet remains intact on the surfaces of the protrusions 31.

The protrusion-forming roller is produced by, for example, forming depressions at predetermined positions on the surface of a ceramic roller by laser machining. The ceramic roller comprises a core roller and a flame sprayed layer formed on the surface of the core roller. For the core roller, an iron roller, a stainless steel roller, or the like may be used. The flame sprayed layer is formed by flame spraying a ceramic material such as chromium oxide uniformly on the surface of the core roller. The depressions are formed on the flame sprayed layer.

In place of the ceramic roller, a cemented carbide roller, a hard iron-based roller, and the like may be used. The cemented carbide roller comprises the same core roller as described above, and a cemented carbide layer being formed on the surface of the core roller and containing cemented carbide such as tungsten carbide. The cemented carbide roller is formed by inserting the core roller in a cylinder of cemented carbide which has been warmed and expanded, or inserting the core roller which has been cooled and shrunk in a cylinder of cemented carbide. The hard iron-based roller has a hard iron layer containing high-speed steel, forged steel, and the like on at least the surface thereof. In these rollers, the depressions are formed on the cemented carbide layer and the hard iron layer by laser machining.

The negative electrode active material layer 22 includes a plurality of columns 32. The columns 32 are supported on the surfaces of the protrusions 31 so as to extend outward and are spaced apart from one another. A gap is present between a pair of columns 32 adjacent to each other.

The column 32 includes at least two alloy-based active materials selected from the group consisting of silicon, tin, a silicon oxide, and a tin oxide. The alloy-based active material absorbs lithium ions by alloying with lithium ions and reversibly absorbs and desorbs lithium ions at a negative electrode potential. Examples of the silicon oxide include silicon oxides represented by the formula: SiOₐ, where 0<a<1.99, preferably 0.05<a<1.95. Examples of the tin oxide include tin oxides represented by the formula: SnO_{b}, where 0<b≦2.

The column 32 comprises the first portion 35 supported on the surface of the protrusion 31, the second portion 36 supported on the surface of the first portion 35, and the third portion 37 supported on the surface of the second portion 36. In short, the column 32 is a stack of the first portion 35, the second portion 36, and the third portion 37. The surface of the third portion 37 not in contact with the second portion 36 is the tip end surface of the column 32.

The first portion 35 is formed on the surface of the protrusion 31. Of the two surfaces of the first portion 35 in the thickness direction of the negative electrode 11, one is in contact with the surface of the protrusion 31, and the other is in contact with the second portion 36. The first portion 35 includes a silicon oxide or a tin oxide as an alloy-based active material. The amount of oxygen contained in the silicon oxide or the tin oxide (hereinafter referred to as the “oxygen content”) in the first portion 35 decreases stepwise as approaching the second portion 36, in the thickness direction of the negative electrode 11.

More specifically, the first portion 35 is formed as a stack of films 60, 61 and 62 as shown in FIG. 4. The films 60, 61 and 62 include a silicon oxide or a tin oxide. The oxygen content in the film 61 is lower than that in the film 60. The oxygen content in the film 62 is lower than that in the film 61. In such a way, the oxygen content in the first portion 35 decreases stepwise as approaching the second portion 36.

The first potion 35 is provided for stably bonding together the protrusion 31 and the second portion 36 highly capable of absorbing lithium ions. In general, with regard to a film including a silicon oxide or a tin oxide, the lower the oxygen content is, the larger the changes in volume and stresses generated in association with the changes in volume become. In the first portion 35, the oxygen content is decreased stepwise, so that the film 62 in contact with the second portion 36 has an oxygen content close to the oxygen content in a film 63 of the second portion 36. As such, the difference between the stresses generated in the films 62 and 63 being in contact with each other is reduced, and the directions in which stresses act do not change significantly.

As such, the occurrence of a crack at the interface between the first portion 35 and the second portion 36 is prevented, and a separation of the second portion 36 and the third portion 37 from the first portion 35 is also prevented. Consequently, the side reaction becomes less likely to occur between the active surface of the silicon oxide or the tin oxide and the non-aqueous electrolyte, which makes it possible to avoid an excessive consumption of the silicon oxide or the tin oxide and the non-aqueous electrolyte, a gas generation which will be a main cause of the battery swelling, and the like. As a result, the deterioration in cycle characteristics, the battery swelling, and the like are prevented.

In the first portion 35, the oxygen content in the film 60 which is in contact with the surface of the protrusion 31 is set high, thereby to minimize the changes in volume of the film 60. As such, the separation of the column 32 from the protrusion 31 is highly prevented. In addition, the stresses applied to the sheet portion 30 from the columns 32 via the protrusions 31 are reduced. As a result, the deformation (buckling) of the negative electrode current collector 21 is prevented.

The oxygen content in the first portion 35 as a whole is preferably 25% by mass to 50% by mass. The oxygen content in the first portion 35 can be adjusted within this range by, for example, selecting the oxygen content in the film 60 to be within the range of 40% by mass to 50% by mass, selecting the oxygen content in the film 61 to be lower than that in the film 60 and within the range of 35% by mass to 45% by mass, and selecting the oxygen content in the film 62 to be lower than that in the film 61 and within the range of 30% by mass to 40% by mass.

When the oxygen content in the first portion 35 is too small, there is a possibility that comparatively large stresses are generated at the interface between the protrusion 31 and the first portion 35, and a separation of the column 32 from the protrusion 31 and the like occur, causing the cycle characteristics to deteriorate. When the oxygen content in the first portion 35 is too large, there is a possibility that the difference between the stresses generated in the first portion 35 and the second portion 36 is increased, and a crack, a drop of a fragment of the alloy-based active material, and the like occur at the interface between the first portion 35 and the second portion 36 or in the vicinity thereof, causing the cycle characteristics to deteriorate.

In the first portion 35, the difference between the oxygen contents in the silicon oxide or the tin oxide in the adjacent two films (i.e., between the films 60 and 61, and between the films 61 and 62) is preferably 10% by mass to 45% by mass. When the difference is too small, there is a possibility that the function of the first portion 35 to bond together the first portion 31 and the second portion 36 becomes insufficient. When the difference is too large, there is a possibility that the stresses generated in association with the changes in volume of the first portion 35 are increased, causing a crack, a drop, and the like to occur.

The thickness of the first portion 35 is preferably 0.4 μm to 7.5 μm, and more preferably 3 μm to 6 μm. Although the thickness of the first portion 35 is not uniform as shown in FIGS. 3 and 4, it is possible to suppress the comparatively large changes in volume of the second portion 36, as long as the thickness of the first portion 35 measured at a randomly selected point is within the above range. As a result, the separation of the column 32 from the protrusion 31 can be prevented. Further, the occurrence of a crack on the surface of the column 32, a drop of a fragment of the alloy-based active material, and the like can be prevented.

When the thickness of the first portion 35 is too small, it is difficult to decrease the oxygen content stepwise in the first portion 35. As a result, it may become difficult to sufficiently suppress the comparatively large changes in volume of the second portion 36. When the thickness of the first portion 35 is too large, the thickness of the second portion 36 becomes small because there is a design restriction on the thickness of the negative electrode 11 in the non-aqueous electrolyte secondary battery 1. Since the second portion 36 is an area to and from which a large amount of lithium is absorbed and desorbed, if the thickness of the second portion 36 is small, there is a possibility that the capacity of the negative electrode 11 is reduced.

The thickness of the first portion 35 is a width of the first portion 35 in the thickness direction of the negative electrode 11. The thickness of the first portion 35 can be measured by observing a cross section of the negative electrode under a scanning electron microscope.

The first portion 35 of this embodiment may include a different film having an oxygen content which falls outside the decreasing gradient of the oxygen content in the first portion 35. Specifically, it suffices if the decrease of the oxygen content in the first portion 35 is an average tendency in the entire first portion 35.

The different film may be, for example: a stack of thin films composed of a silicon oxide or a tin oxide, the oxygen content in which increases as approaching the second portion 36; a thin film being composed of a silicon oxide or a tin oxide, the oxygen content in which is almost constant, or a stack of these thin films; and the like. Due to the presence of the different film, the stresses generated in the first portion 35 are offset by each other, and thus the first portion 35 is more stably maintained. In order to avoid an increase in the difference between the stresses generated in the different film and those in the films 60, 61 and 62, the thickness of the different film is preferably set to be 10% or less of the minimum thickness of the first portion 35. The first portion 35 may include two or more different films.

For example, the different films are formed so as to be interspersed at the interface between the film 60 and the film 61, the interface between the film 61 and the film 62, and the like. Such different films can be formed with a vacuum vapor deposition apparatus by using a mask having a predetermined shape.

The first portion 35 of this embodiment is a stack of the films 60, 61 and 62, but not limited thereto and may be a stack of any number of two or more films. Further, in the first portion 35 of this embodiment, the oxygen content is decreased stepwise, but not limited thereto and may be decreased continuously.

The second portion 36 is formed on the surface of the first portion 35. Of the two surfaces of the second portion 36 in the thickness direction of the negative electrode 11, one is in contact with the surface of first portion 35, and the other is in contact with the third portion 37. The second portion 36, which includes silicon or tin as an alloy-based active material, is provided for increasing the lithium-absorbing ability of the columns 32 and thus increasing the capacity and the output of the negative electrode 11. Silicon and tin are capable of absorbing a larger amount of lithium than silicon oxides or tin oxides, but disadvantageously, exhibit a larger change in volume when lithium is absorbed thereto. It is possible, however, to improve the lithium-absorbing ability of the columns 32 as well as to highly prevent the separation of the column 32 from the protrusion 31 by, as in this embodiment, forming the second portion 36 on the protrusion 31 with the first portion 35 interposed therebetween instead of directly forming the second portion 36 on the surface of the protrusion 31.

The second portion 36 is a stack of films 63, 64, 65, 66, 67, 68 and 69 (hereinafter referred to as “films 63 to 69”). The films 63 to 69 each include silicon or tin as an alloy-based active material. Due to the presence of the second portion 36 formed as a stack of two or more films 63 to 69, the stresses generated in association with the changes in volume of the alloy-based active material can be reduced. Here, the number of films forming the second portion 36 may be any number of one or more.

There is a case where the second portion 36 includes a silicon oxide or a tin oxide as an inevitable impurity.

This happens because a vacuum vapor deposition apparatus used in forming the first portion 35 is subsequently used in forming the second portion 36 when a low cost production on an industrial scale is intended. Oxygen remains in the vacuum vapor deposition apparatus after the formation of the first portion 35, and it is difficult to completely remove the remaining oxygen. The oxygen content in the second portion 36 as a whole formed in such a case is 1% by mass to 25% by mass. There is little possibility, however, that the oxygen content in the second portion 36 greatly exceeds 25% by mass because no oxygen is used in forming the second portion 36.

In the case where a vacuum vapor deposition apparatus used in forming the first portion 35 is subsequently used in forming the second portion 36, the oxygen content in the second portion 36 composed of the films 63 to 69 tends to be highest at the film 63, gradually decreases from the film 63 toward the film 69, and lowest at the film 69.

The thickness of the second portion 36 is preferably 0.85 μm to 15.5 μm, and more preferably 7 μm to 12 μm. The thickness of the second portion 36 is not uniform as shown in FIGS. 3 and 4. However, as long as the thickness measured at any point of the second portion 36 is within the above range, the lithium-absorbing ability of the columns 32 is significantly improved. In addition, the stresses generated in association with the changes in volume of the second portion 36 are reduced by the first portion 35 and the third portion 37.

When the thickness of the second portion 36 is too small, the column 32 is composed mostly of the first portion 35 and the third portion 37, in both of which the oxygen content is comparatively high, and therefore, there is a possibility that the lithium-absorbing ability of the columns 32 is reduced. When the thickness of the second portion 36 is too large, the stresses generated in association with the changes in volume are increased. As a result, a crack, a drop of a fragment of the alloy-based active material, and the like become more likely to occur at the interface between the first portion 35 and the second portion 36. Further, there is a possibility that the second portion 36 and the third portion 37 are separated from the first portion 35 in the vicinity of the above interface.

The second portion 36 may include in its interior a different film having a comparatively high oxygen content. Due to the presence of such a different film, the stresses generated in the interior of the second portion 36 are reduced. The oxygen content in this different film is, for example, 20% by mass to 40% by mass. In order to avoid an increase in the difference between the stresses generated in the different film and those in the films 63 to 69, the thickness of the different film is preferably set to be 10% or less of the minimum thickness of the second portion 36, and more preferably set to be 5% or less. It is preferable to form such different films, for example, so as to be interspersed at the interfaces between the films.

The third portion 37 is formed on the surface of the second portion 36. Of the two surfaces of the third portion 37 in the thickness direction of the negative electrode 11, one is in contact with the surface of second portion 36, and the other is the top end surface of the column 32. The third portion 37 includes a silicon oxide or a tin oxide as an alloy-based active material. The oxygen content in the third portion 37 is increased stepwise with distance from the second portion 36. The direction of distancing from the second portion 36 coincides with the direction from the surface of the protrusion 31 toward the top end surface of the column 32 (the surface of the third portion 37).

The third portion 37 is formed as a stack of films 70, 71 and 72 as shown in FIG. 4. The films 70, 71 and 72 include a silicon oxide or a tin oxide. The oxygen content in the film 71 is higher than that in the film 70, and the oxygen content in the film 72 is higher than that in the film 71. In such a manner, in the third portion 37, the oxygen content increases stepwise with distance from the second portion 36.

The third portion 37 is provided for, for example, preventing the second portion 36 from getting exposed on the tip end of the column 32. Among stresses generated in association with the changes in volume of the column 32, the stresses directed to the side surface of the column 32 are absorbed by the gap around the side surface of the column 32. In contrast, since the top end of the column 32 is in proximity to or in contact with the separator 13, there is little space above the column 32 for absorbing the stresses generated in association with the changes in volume of the column 32. As such, if the second portion 36 whose changes in volume is large is exposed on the tip end, a crack or a drop in the column 32, a separation of the column 32 from the protrusion 31, and the like become more likely to occur. In addition, there is a possibility that the separator 13 is damaged.

However, by providing the film 72 having a comparatively high oxygen content at the tip end of the column 32, a crack and the like become less unlikely to occur, and the possibility that that the separator 13 is damaged is reduced, even when the top end of the column 32 is in proximity to or in contact with the separator 13.

The third portion 37 is provided also for preventing the occurrence of a crack and a drop of the alloy-based active material in the second portion 36. Specifically, the film 70 having a relatively low oxygen content is provided at the interface between the second portion 36 and the third portion 37. Consequently, the difference between the stresses generated in the film 70 and the second portion 36 becomes comparatively small, and thus the stresses generated in the second portion 36 can be reduced. As a result, it is possible to prevent a crack, a drop, and the like from occurring in the second portion 36 at the interface between the second portion 36 and the third portion 37 or in the vicinity thereof.

The oxygen content in the third portion 37 as a whole is preferably within the range of 10% by mass to 50% by mass. The oxygen content in the third portion 37 can be controlled within this range by, for example, selecting the oxygen content in the film 70 to be within the range of 20% by mass to 35% by mass, selecting the oxygen content in the film 71 to be higher than that in the film 70 and within the range of 30% by mass to 45% by mass, selecting the oxygen content in the film 72 to be higher than that in the film 71 and within the range of 40% by mass to 50% by mass.

When the oxygen content in the third portion 37 is too small, a crack, a drop of a fragment of the alloy-based active material, and the like become more likely to occur in the third portion 37. The crack, if formed, would propagate throughout the column 32 with the increase in the number of charge/discharge cycles, causing a separation of the column 32 from the protrusion 31, and the like. When the oxygen content in the third portion 37 is too large, the difference between the stresses generated in the second portion 36 and the third portion 37 is increased, and therefore, there is a possibility that a crack, a drop of a fragment of the alloy-based active material, and the like easily occur mainly at the interface between the third portion 37 and the second portion 36 or in the vicinity thereof.

In the third portion 37, the difference between the oxygen contents in the silicon oxide or the tin oxide in the adjacent two films (i.e., between the films 70 and 71, and between the films 71 and 72) is preferably within the range of 10% by mass to 45% by mass. When the difference is too small, there is a possibility that the increasing gradient of the oxygen content becomes small, and as a result, the function of the third portion 37 to prevent the occurrence of a crack, a drop, and the like in the second portion 36 becomes insufficient. When the difference is too large, there is a possibility that the increasing gradient of the oxygen content becomes too large, and as a result, the difference among the stresses generated in the films 70, 71 and 72 is increased, and thus a crack, a drop, or the like easily occur in the third portion 37 itself.

The thickness of the third portion 37 is preferably 0.3 μm to 7.5 μm, and more preferably 1 μm to 4 μm. The thickness of the third portion 37 is not uniform as shown in FIGS. 3 and 4. However, it is possible to suppress the comparatively large changes in volume of the second portion 36, as long as the thickness of the third portion 37 measured at a randomly selected point is within the above range. As a result, the separation of the column 32 from the protrusion 31 can be prevented. Further, the occurrence of a crack on the surface of the column 32, a drop of a fragment of the alloy-based active material, and the like can be prevented.

When the thickness of the third portion 37 is too small, there is a possibility that increasing stepwise the oxygen content in the third portion 37 becomes difficult, and as a result, the function of the third portion 37 to prevent the occurrence of a crack, a drop, and the like in the second portion 36 becomes insufficient. When the thickness of the third portion 37 is too large, the thicknesses of the first portion 35 and the second portion 36 become comparatively small because there is a design restriction on the thickness of the negative electrode 11 in the non-aqueous electrolyte secondary battery 1. If the thickness of the first portion 35 is too small, it may happen that a separation of the column 32 from the protrusion 31 easily occurs. If the thickness of the second portion 36 is too small, it may happen that the capacity of the negative electrode 11 is reduced.

Although the oxygen content in the third portion 37 of this embodiment increases stepwise, the third portion 37 may include a different film having an oxygen content which falls outside the gradient of the oxygen content in the third portion 37. The third portion 37 may include two or more difference films. It suffices if the stepwise increase of the oxygen content in the third portion 37 is an average tendency in the entire third portion 37.

The different film may be, for example: a stack of thin films composed of a silicon oxide or a tin oxide, the oxygen content in which increases continuously or stepwise with distance from the second portion 36; a thin film being composed of a silicon oxide or a tin oxide, the oxygen content in which is almost constant, or a stack of these thin films; and the like. Due to the presence of the different film, the stresses generated in the third portion 37 are offset by each other, and thus the third portion 37 is more stably maintained. In order to avoid an increase in the difference between the stresses generated in the different film and those in the films 70, 71 and 72, the thickness of the different film is preferably set to be 10% or less of the minimum thickness of the third portion 37.

For example, the different films are formed so as to be interspersed at the interface between the film 70 and the film 71, the interface between the film 71 and the film 72, and the like. Such different films can be formed with a vacuum vapor deposition apparatus by using a mask having a predetermined shape.

The third portion 37 of this embodiment is a stack of the films 70, 71 and 72, but not limited thereto and may be a stack of any number of two or more films. Further, in the third portion 37 of this embodiment, the oxygen content is increased stepwise, but not limited thereto and may be increased continuously. The oxygen content can be increased continuously by, for example, increasing continuously the amount of oxygen supplied to a vacuum vapor deposition apparatus according to a predetermined increasing gradient of oxygen concentration.

In the column 32 of this embodiment, when the first portion 35 includes a silicon oxide, it is preferable that the second portion 36 includes silicon, and the third portion 37 includes a silicon oxide. When the first portion 35 includes a tin oxide, it is preferable that the second portion 36 includes tin, and the third portion 37 includes a tin oxide.

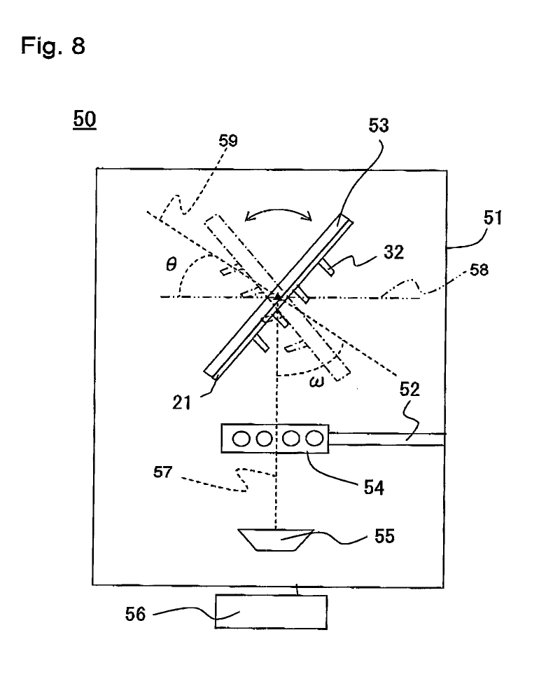

The columns 32 can be formed with, for example, an electron beam vacuum vapor deposition apparatus 50 as shown in FIG. 8 (hereinafter simply referred to as a “vapor deposition apparatus 50”). FIG. 8 is a side perspective view schematically showing the configuration of the vapor deposition apparatus 50. The protrusions 31 on the negative electrode current collector 21 are not shown in FIG. 8.

The vapor deposition apparatus 50 includes a chamber 51, a first pipe 52, a support table 53, a nozzle 54, a target 55, an electron beam generating apparatus (not shown), and a power source 56.

The chamber 51 is a pressure-resistant container and accommodates in its interior the first pipe 52, the support table 53, the nozzle 54, and the target 55.

One end of the first pipe 52 is connected to the nozzle 54, and the other end extends outside the chamber 51 and is connected to an oxygen tank or an oxygen producing apparatus (not shown) via a mass flow controller (not shown). The first pipe 52 supplies oxygen to the nozzle 54.

The support table 53 turns alternately so as to move between the positions indicated by the solid line and by the dot-dash line, while the negative electrode current collector 21 is supported on one surface of the support table 53. The position indicated by the solid line is a position where the support table 53 and a horizontal line 58 forms an angle of (90−ω)°=θ°. The position indicated by the dash-dot line is a position where the support table 53 and the horizontal line 58 forms an angle of (180−θ)°. The angle ω formed between a vertical line 57 and a perpendicular line 59 is an incident angle of alloy-based active material vapor with respect to the negative electrode current collector 21. The angle w is adjusted according to the design dimensions of the column 32. The perpendicular line 59 is a straight line passing through the point of intersection of the vertical line 57 and the fixing table 53 and being perpendicular to the surface of the support table 53.

The nozzle 54 is connected to one end of the first pipe 52 between the support table 53 and the target 55, and releases oxygen supplied from the first pipe 52 into the chamber 51. The target 55 holds silicon or tin. The electron beam generating apparatus irradiates the target 55 with electron beams, to generate vapor of silicon or tin. The power source 56 applies a voltage to the electron beam generating apparatus. An electron beam vapor deposition apparatus having the same configuration as that of the vapor deposition apparatus 50 is commercially available from, for example, Ulvac Inc.

The operation of the vapor deposition apparatus 50 is described below. First, the negative electrode current collector 21 is fixed on the support table 53, and oxygen is supplied into the chamber 51 from the nozzle 54. The target 55 is then irradiated with electron beams, so that vapor of silicon or tin is generated therefrom. The vapor goes up vertically and is mixed with oxygen. This mixed gas further goes up to be vapor deposited on the surfaces of the protrusions 31 of the negative electrode current collector 21. As a result, a film including a silicon oxide or a tin oxide is formed. Here, in forming the first portions 35 and the third portions 37, a predetermined amount of oxygen is supplied stepwise into the chamber 51 from the nozzle 54; and in forming the second portions 36, no oxygen is supplied.

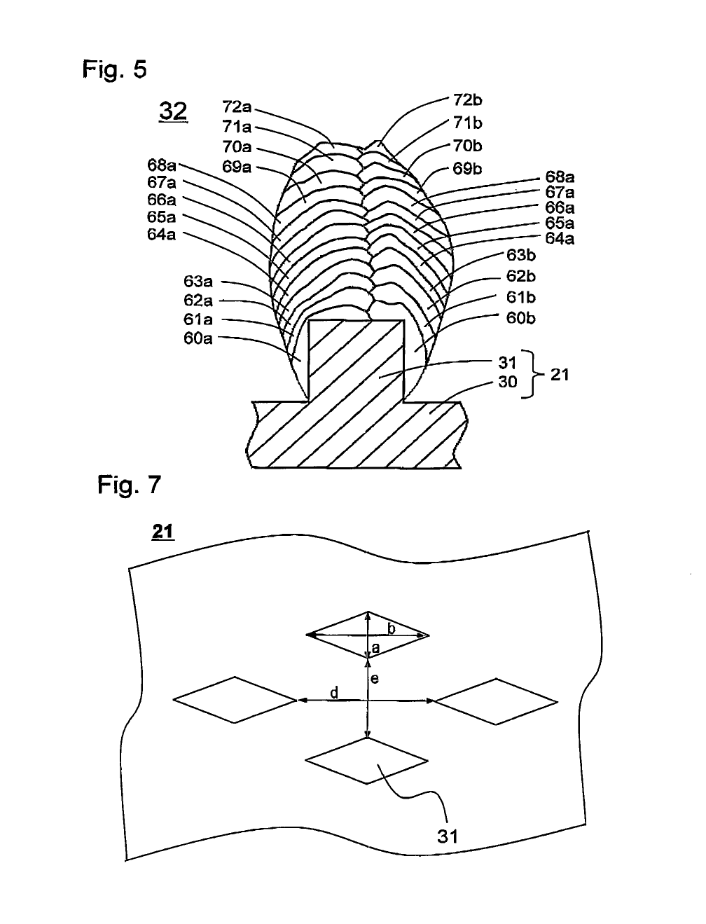

The formation of the columns 32 using the vapor deposition device 50 is more specifically described below with reference to FIG. 5. FIG. 5 is a longitudinal cross-sectional view for explaining a production method of the column 32.

First, the support table 53 is set at the position indicated by the solid line, and vacuum vapor deposition is performed while the oxygen is supplied into the chamber 51, to form a film piece 60a. Subsequently, the support table 53 is set at the position indicated by the dash-dot line, and vacuum vapor deposition is performed while oxygen is supplied at the same flow rate as above, to form a film piece 60b. In such a manner, the film 60 composed of the film pieces 60a and 60b is formed. Subsequently, film pieces 61a and 61b are formed in the same manner as the film pieces 60a and 60b, except that oxygen is supplied at a lower flow rate, thereby to form the film 61. Subsequently, film pieces 62a and 62b are formed in the same manner as the film pieces 61a and 61b, except that oxygen is supplied at a further lower flow rate, thereby to form the film 62. In such a manner, the first portion 35 is formed.

Next, the supply of oxygen is halted, and the vacuum vapor deposition is performed while the support table 53 is alternately set at the position indicated by the solid line and by the dash-dot line, to form fourteen film pieces 63a, 63b to 69a and 69b. In such a manner, the second portion 36 is formed.

Next, the supply of oxygen is resumed, and the vacuum vapor deposition is performed. A film piece 70a is formed while the support table 53 is set at the position indicated by the solid line, and a film piece 70b is formed while the support table 53 is set at the position indicated by the dash-dot line, thereby to form the film 70. Subsequently, film pieces 71a and 71b are formed in the same manner as the film pieces 70a and 70b, except that oxygen is supplied at a higher flow rate, thereby to form the film 71. Subsequently, film pieces 72a and 72b are formed in the same manner as the film pieces 71a and 71b, except that oxygen is supplied at a further higher flow rate, thereby to form the film 72. In such a manner, the third portion 37 is formed, and thus the column 32 is formed.

According to the production method of this embodiment, the column 32 including the first portion 35 and the third portion 37, in each of which the oxygen content changes stepwise is obtained. When oxygen is supplied into the chamber 51 at a continuously increasing rate or at a continuously decreasing rate according to a predetermined oxygen concentration gradient, the column 32 including the first portion 35 and the third portion 37, in each of which the oxygen content changes continuously is obtained.

The column 32 is formed by vacuum vapor deposition, which is one of vapor phase methods, in this embodiment, but not limited thereto and may be formed by any vapor phase method other than vacuum vapor deposition method. Examples of vapor phase methods include sputtering, ion plating, laser ablation, chemical vapor deposition, plasma chemical vapor deposition, and flame spray coating.

In the negative electrode 11 of this embodiment, the negative electrode active material layer 22 being an aggregate of the columns 32 is foamed on the surface of the negative electrode current collector 21 with the protrusions 31 formed thereon, but this is not a limitation, and a sheet-like negative electrode active material layer may be formed on a negative electrode current collector with or without the protrusions 31 formed thereon. The sheet-like negative electrode active material layer can be formed by performing vacuum vapor deposition in the vapor deposition apparatus 50 while the support table 53 is positioned along the horizontal line 58.

Component members other than the negative electrode 11 in the non-aqueous electrolyte secondary battery 1 are described below.

The positive electrode 12 includes a positive electrode current collector 23 and a positive electrode active material layer 24.

The positive electrode current collector 23 may be a conductive substrate. Examples of the conductive substrate include porous conductive substrates such as mesh, net, perforated sheet, lath, porous material, foam, and nonwoven fabric; and non-porous conductive substrates such as foil, sheet, and film. The conductive substrate may be made of, for example, a metal material such as stainless steel, titanium, aluminum, and aluminum alloy, or a conductive resin. The thickness of the conductive substrate is preferably 1 μm to 500 μm, and more preferably 1 μm to 50 μm.

The positive electrode active material layer 24 is provided on one surface of the positive electrode current collector 23 and includes a positive electrode active material, a conductive agent, and a binder. The positive electrode active material layer 24 of this embodiment is provided on one surface of the positive electrode current collector 23, but not limited thereto and may be provided on both surfaces.

For the positive electrode active material, any known positive electrode active material for a non-aqueous electrolyte secondary battery may be used, but a lithium-containing composite oxide, an olivine type lithium phosphate, and the like are preferred.

The lithium-containing composite oxide is a metal oxide containing lithium and a transition metal element or an oxide in which part of the transition metal element in the metal oxide is substituted by a different element. Examples of the transition metal element include Mn, Fe, Co, Ni, Sc, Y, Cu, and Cr, among which Mn, Fe, Co and Ni are preferred. Examples of the different element include Na, Mg, Zn, Al, Pb, Sb, and B, among which Mg and Al are preferred. These transition metal elements may be used singly or in combination of two or more; and these different elements may be used singly or in combination of two or more.

Examples of the lithium-containing composite oxide include Li_{q}CoO₂, Li_{q}NiO₂, Li_{q}MnO₂, Li_{q}COₘNi₁₋ₘO₂, Li_{q}Co₁₋ₘA₁₋ₘOₙ, Li_{q}Ni₁₋ₘAₘOₙ, Li_{q}Mn₂O₄, and Li_{q}Mn₂₋ₘAₙO₄, where A represents at least one element selected from the group consisting of Na, Mg, Sc, Y, Mn, Fe, Co, Ni, Cu, Zn, Al, Cr, Pb, Sb and B, 0<q≦1.2, 0≦m≦0.9 and 2≦n≦2.3.

Examples of the olivine-type lithium phosphate include LiXPO₄ and Li₂KPO₄F, where X represents at least one element selected from the group consisting of Co, Ni, Mn and Fe.

The molar ratio of lithium in each formula above is a molar ratio measured immediately after the positive electrode active materials represented by the formulae above are produced, and increases or decreases during charging and discharging. The positive electrode active materials may be used singly or in combination of two or more.

Examples of the conductive agent include graphites such as natural graphite and artificial graphite; carbon blacks such as acetylene black, Ketjen black, channel black, furnace black, lamp black, and thermal black; conductive fibers such as carbon fiber and metal fiber; fluorinated carbon and the like. These conductive agents may be used singly or in combination of two or more.

Examples of the binder include resin materials such as polyvinylidene fluoride, polytetrafluoroethylene, polyethylene, polypropylene, polyamide, polyimide, polyhexafluoropropylene, polyamide-imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyether, polyether sulfone, and copolymers obtained by copolymerizing two or more monomers; rubber materials such as styrene-butadiene rubber and modified acrylic rubber and the like.

Examples of the monomers include tetrafluoroethylene, perfluoroalkylvinylether, vinylidene fluoride, chlorotrifluoroethylene, ethylene, propylene, hexafluoropropylene, pentafluoropropylene, acrylic acid, methacrylic acid and the like. These binders may be used singly or in combination of two or more.

The positive electrode active material layer 24 can be formed by mixing the positive electrode active material, conductive agent, and binder with an organic solvent, to give a positive electrode material mixture slurry, applying the slurry thus obtained onto a surface of the positive electrode current collector 23, and drying and rolling the coating film thus obtained. The organic solvent may be dimethylformamide, dimethylacetamide, methylformamide, N-methyl-2-pyrrolidone, dimethylamine, acetone, cyclohexanone, and the like.

The separator 13 is arranged between the negative electrode 11 and the positive electrode 12 and provides electrical insulation therebetween. The separator 13 may be a porous sheet having predetermined levels of lithium ion permeability, mechanical strength, and insulating property. Examples of the porous sheet include microporous film, woven fabric, and non-woven fabric. The microporous film may be of a single-layer film or a multi-layer film made of the same resin material, or of a multi-layer film being a laminate of single-layer films made of different resin materials.

The separator 13 is made of a resin material. A preferred resin material is polyolefin such as polyethylene and polypropylene, in view of the durability and shutdown function of the separator 13, the safety of the battery, and other factors. The thickness of the separator 13 is 10 μm to 300 μm, and preferably 10 μm to 40 μm. The porosity of the separator 13 is preferably 30% to 70%, and more preferably 35 to 60%.

The negative electrode lead 14 may be a nickel lead, a copper lead, and the like. The positive electrode lead 15 may be an aluminum lead and the like. The gasket 16 can be made by molding an insulating material such as a resin material and a rubber material into a predetermined shape. The battery case 17 can be made by molding a metal material, a resin material, a laminate film, and the like into a predetermined shape.

The non-aqueous electrolyte to be impregnated mainly into the electrode assembly 10 includes a lithium salt and a non-aqueous solvent.

Examples of the lithium salt include LiClO₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, LiBCl₄, borates of lithium, and imides of lithium. These lithium salts may be used singly or in combination of two or more. The concentration of the lithium salt is preferably 0.5 to 2 mol per liter of the non-aqueous solvent.

Examples of the non-aqueous solvent include cyclic carbonic acid esters such as propylene carbonate and ethylene carbonate; chain carbonic acid esters such as diethyl carbonate, ethyl methyl carbonate, and dimethyl carbonate; cyclic carboxylic acid esters such as γ-butyrolactone and γ-valerolactone, and the like. These non-aqueous solvents may be used singly or in combination of two or more.

Although the non-aqueous electrolyte secondary battery described in this embodiment is a thin battery including a stacked electrode assembly, the non-aqueous electrolyte secondary battery of the present invention is not limited thereto, and may be in various forms, for example, may be a coin battery including a stacked electrode assembly, a cylindrical battery including a wound electrode assembly, a prismatic battery including a flat electrode assembly, a laminate film battery including a stacked electrode assembly or a flat electrode assembly. The wound electrode assembly is obtained by winding a positive electrode and a negative electrode with a separator interposed therebetween. The flat electrode assembly is obtained by press-molding a wound electrode assembly into a flat shape.

The non-aqueous electrolyte secondary battery of the present invention is applicable for the same applications as those of the conventional non-aqueous electrolyte secondary batteries, and is particular useful as a main power source or an auxiliary power source for electronic equipment, electric equipment, machining equipment, transportation equipment, and power storage equipment. Examples of the electronic equipment include personal computers, cellular phones, mobile devices, personal digital assistants, and portable game machines. Examples of the electric equipment include vacuum cleaners and video cameras. Examples of the machining equipment include electric power tools and robots. Examples of the transportation equipment include electric vehicles, hybrid electric vehicles, plug-in HEVs, and fuel cell-powered vehicles. Examples of the power storage equipment include uninterrupted power supplies.

### EXAMPLE

The present invention is specifically described below with reference to Examples and Comparative Examples.

### Example 1

### (1) Preparation of Positive Electrode Active Material

To an aqueous nickel sulfate solution, cobalt sulfate was added, to prepare an aqueous solution having a metal ion concentration of 2 mol/L and Ni:Co=8.5:1.5 (molar ratio). To the resultant aqueous solution while being stirred, an aqueous 2 mol/L sodium hydroxide solution was added dropwise. The precipitate formed was collected by filtration, washed with water, and dried at 80° C., to give a composite hydroxide represented by Ni_{0.85}Cu_{0.15}(OH)₂.

The resultant composite hydroxide was heated at 900° C. in air for 10 hours, to give a composite oxide represented by Ni_{0.85}CO_{0.15}O. The composite oxide thus obtained was mixed with a lithium hydroxide monohydrate such that the total number of Ni and Co atoms became equal to the number of Li atoms, and heated at 800° C. in air for 10 hours, to give a lithium-nickel-containing composite oxide (a positive electrode active material) being represented by LiNi_{0.85}CO_{0.85}O₂ and having an average secondary particle diameter of 10 μm.

### (2) Production of Positive Electrode

First, 93 g of the positive electrode active material powder obtained in the above, 3 g of acetylene black (conductive agent), 4 g of polyvinylidene fluoride powder (binder), and 50 mL of N-methyl-2-pyrrolidone were mixed sufficiently to prepare a positive electrode material mixture slurry. The positive electrode material mixture slurry thus prepared was applied onto one surface of a 15-μm-thick aluminum foil (positive electrode current collector), then dried and rolled, to form a positive electrode active material layer having a thickness of 60 μm. The positive electrode thus formed was cut in the size of 30 mm×380 mm, to give a positive electrode plate.

### (3) Production of Negative Electrode Current Collector

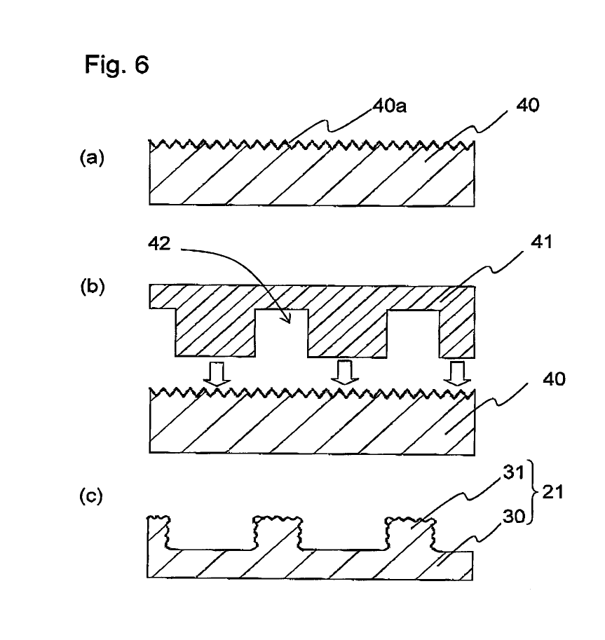

FIG. 6 is a set of longitudinal cross-sectional views showing a production method of the negative electrode current collector 21. FIG. 7 is a top view schematically showing a configuration of an essential part of the negative electrode current collector 21 obtained by the production method shown in FIG. 6. The negative electrode current collector 21 was produced according to FIGS. 6 and 7.

The production method of the negative electrode current collector 21 shown in FIG. 6 includes the steps shown in FIG. 6(a) and FIG. 6(b).

In the step shown in FIG. 6(a), one surface 40a of a 27-μm-thick copper foil (trade name: HCL-02Z, available from Hitachi Cable, Ltd.) was roughened by electrolysis, so that the surface 40a have a plurality of 1-gm-diameter copper particles. In such a manner, a surface-roughened copper foil 40 having a surface roughness of Rz=1.5 μm was obtained. The surface roughness Rz is a ten-point average height specified in the Japanese Industrial Standard (JISB 0601-1994). A commercially available copper foil with roughened surface for printed circuit boards may be used in place of the surface-roughened copper foil 40.

In the step shown in FIG. 6(b), a plurality of recesses 42 were formed on the surface of a forged steel roller 41 by laser engraving. The recess 42 had the shape of a rhombus. The lengths of the short diagonal and the long diagonal of the rhombus were 10 μm and 20 μm, respectively. The distances between adjacent recesses 42 along the short diagonal and the long diagonal were 18 μm and 20 μm, respectively. The depth of the recess 42 was 10 μm. The forged steel roller 41 and a stainless steel roller with smooth surface were press-fitted at a line pressure of 1 t/cm with the axes of the two rollers being arranged parallel to each other so that a press fit portion was formed therebetween. The surface-roughened copper foil 40 was allowed to pass through the press fit portion between the two rollers in such a manner that the roughened surface 40a of the surface-roughened copper foil 40 was brought into contact with the surface of the forged steel roller 41.

The negative electrode current collector 21 with a plurality of the protrusions 31 formed on its surface as shown in FIG. 6(c) was thus obtained. In this process, an area of the surface-roughened copper foil 40 pressed by a face of the forged steel roller 41 where no recess 42 was formed was flattened. An area of the surface-roughened copper foil 40 pressed by a face of the forged steel roller 41 where the recesses 42 were formed was plastically deformed and entered the internal spaces of the recesses 42, forming the protrusions 31. The surface roughness of the roughened surface 40a of the surface-roughened copper foil 40 remained substantially intact on the surfaces of the protrusions 31. The height of the protrusions 31 was smaller than the depth of the recesses 42 on the forged steel roller 41, and was about 8 μm.

As shown in FIG. 7, the protrusions 31 each having the shape of an approximate rhombus were arranged in a staggered pattern on the surface of the negative electrode current collector 21. Of the diagonals of the protrusion 31, the length of the short diagonal “a” was about 10 μm, and the length of the long diagonal “b” was about 20 μm. The distance “e” along the short diagonal “a” between adjacent protrusions 31 was 18 μm, and the distance “d” along the long diagonal “b” was 20 μm.

### (4) Production of Negative Electrode

The negative electrode current collector 21 obtained in the above was cut in the size of 2 cm×10 cm and fixed on the support table 53 of the vapor deposition apparatus 50 shown in FIG. 8. A scrap material being a by-product in semiconductor wafer production (scrap silicon: 99.999% purity) was used as the target 55. While oxygen gas with 99.7% purity was being supplied into the chamber 51, the target 55 was irradiated with electron beams deflected by a deflection yoke, to generate silicon vapor.

First, the support table 53 was set at the position indicated by the solid line (ω=70°), and vacuum vapor deposition was performed for 50 seconds at a film forming rate of about 8 nm/sec and an oxygen flow rate of 1000 sccm, to form the film pieces 60a on part of the surfaces of the protrusions 31. Subsequently, the support table 53 was set at the position indicated by the dash-dot line (ω=−70°), and vacuum vapor deposition was performed without changing the film forming rate, oxygen flow rate, and vapor deposition time, to form the film pieces 60b on the remaining part of the surfaces of the protrusions 31. The films 60 were thus formed.

The films 60 was composed of a silicon oxide having an oxygen content of 50% by mass.

Subsequently, vapor deposition was performed in the same manner as in the above, except the support table 53 was back to the position indicated by the solid line (ω=70°), and the oxygen flow rate was changed from 1000 sccm to 800 sccm, to form the film pieces 61a on the surfaces of the film pieces 60a. Then, the support table 53 was set at the position indicated by the dash-dot line (ω=−70°), and vapor deposition was continued without changing the film forming rate, oxygen flow rate, and vapor deposition time, to form the film pieces 61b on the surfaces of the film pieces 60b. The films 61 composed of a silicon oxide having an oxygen content of 40% by mass were thus formed.

The films 62 (composed of a silicon oxide having an oxygen content of 20% by mass) each composed of the film pieces 62a and 62b were formed in the same manner as the films 60, except that the oxygen flow rate was changed to 400 sccm. The first portions 35 were thus formed. In the first portions 35, the oxygen content was decreased stepwise with distance from the surfaces of the protrusions 31. The oxygen content in the first portions 35 as a whole was 36% by mass. The thickness of the first portion 35 was 4 μm to 5 μm.

Next, the support table 53 was set at the position indicated by the solid line (ω=70°) and the supply of oxygen was halted. In this state, vacuum vapor deposition was performed for 50 seconds at a film forming rate of about 8 nm/sec, to form the film pieces 63a on the surfaces of the film pieces 62a. Then, the support table 53 was set at the position indicated by the dash-dot line (ω=−70°), and vapor deposition was continued without changing the film forming rate and vapor deposition time, to form the film pieces 63b on the surfaces of the film pieces 62b. The films 63 were thus formed. The above procedures were repeated to form the films 64 to 69 composed of the film pieces 64a and 64b, 65a and 65b, 66a and 66b, 67a and 67b, 68a and 68b, and 69a and 69b, respectively. The second portions 36 were thus formed. The second portions 36 were mainly composed of silicon, and the oxygen content in the second portions 36 as a whole was 5% by mass. The thickness of the second portions 36 was 7 μm to 8 μm.

The support table 53 was set at the position indicated by the solid line (ω=70°), and vacuum vapor deposition was performed for 50 seconds at a film forming rate of about 8 nm/sec and an oxygen flow rate of 400 sccm, to form the film pieces 70a on the surfaces of the film pieces 69a. Then, the support table 53 was set at the position indicated by the dash-dot line (ω=−70°), and vapor deposition was continued without changing the film forming rate, oxygen flow rate and vapor deposition time, to form the film pieces 70b on the surfaces of the film pieces 69b. The films 70 composed of a silicon oxide having an oxygen content of 20% by mass were thus formed.

The films 71 each composed of the film pieces 71a and 71b and composed of a silicon oxide having an oxygen content of 40% by mass were formed in the same manner as the films 70, except that the oxygen flow rate was increased from 400 sccm to 800 sccm. The third portions 37 were thus formed. The oxygen content in the third portions 37 as a whole was 30% by mass. The thickness of the third portions 37 was 2 μm to 4 μm.

In such a manner, the columns 32 were formed on the surfaces of the protrusions 31 of the negative electrode current collector 21, and thus negative electrode 11 was obtained. The average height of the columns 32 was 15 μm. The negative electrode 11 thus obtained was cut in the size of 31 mm×390 mm, to give a negative electrode plate.

### (5) Preparation of Non-Aqueous Electrolyte

Ethylene carbonate, ethyl methyl carbonate, and diethyl carbonate were mixed in a ratio of 2:3:5 by volume. LiPF₆ was dissolved in the resultant mixed solvent at a concentration of 1.4 mol/L, to prepare a non-aqueous electrolyte.

### (5) Fabrication of Battery

The positive electrode plate and the negative electrode plate obtained in the above were stacked with a separator (polyethylene microporous film, trade name: Hipore, 20 μm thick, available from Asahi Kasei Corporation) interposed therebetween, to form a stacked electrode assembly. One end of an aluminum lead (positive electrode lead) was welded to the positive electrode current collector, and one end of a nickel lead (negative electrode lead) was welded to the negative electrode current collector. The electrode assembly was accommodated together with the non-aqueous electrolyte in a battery case made of aluminum laminate sheet. The positive and negative electrode leads were extended out of the battery case through the openings at both ends thereof. The openings of the battery case were directly welded while the internal pressure was reduced to a near vacuum. A non-aqueous electrolyte secondary battery was thus fabricated.

### Example 2

Columns composed of the first portions 35 (oxygen content: 30% by mass), the second portions 36 (oxygen content: 4% by mass), and the third portions 37 (oxygen content: 30% by mass) were formed on the surfaces of protrusions 31 on the negative electrode current collector 21 in the same manner as in Example 1, except that the oxygen flow rate in forming the films 60 was changed to 900 sccm, the oxygen flow rate in forming the films 61 was changed to 600 sccm, and the oxygen flow rate in forming the films 62 was changed to 300 sccm, and thus a negative electrode was obtained. The negative electrode was cut in the size of 31 mm×390 mm, to give a negative electrode plate. A non-aqueous electrolyte secondary battery was fabricated in the same manner as in Example 1, except that the negative electrode plate thus obtained was used.

### Example 3

Columns composed of the first portions 35 (oxygen content: 45% by mass), the second portions 36 (oxygen content: 6% by mass), and the third portions 37 (oxygen content: 30% by mass) were formed on the surfaces of protrusions 31 on the negative electrode current collector 21 in the same manner as in Example 1, except that the oxygen flow rate in forming the films 60 was changed to 1600 sccm, the oxygen flow rate in forming the films 61 was changed to 800 sccm, and the oxygen flow rate in forming the films 62 was changed to 300 sccm, and thus a negative electrode was obtained. The negative electrode was cut in the size of 31 mm×390 mm, to give a negative electrode plate. A non-aqueous electrolyte secondary battery was fabricated in the same manner as in Example 1, except that the negative electrode plate thus obtained was used.

### Example 4

Columns composed of the first portions 35 (oxygen content: 20% by mass), the second portions 36 (oxygen content: 3% by mass), and the third portions 37 (oxygen content: 30% by mass) were formed on the surfaces of protrusions 31 on the negative electrode current collector 21 in the same manner as in Example 1, except that the oxygen flow rate in forming the films 60 was changed to 600 sccm, the oxygen flow rate in forming the films 61 was changed to 400 sccm, and the oxygen flow rate in forming the films 62 was changed to 200 sccm, and thus a negative electrode was obtained. The negative electrode was cut in the size of 31 mm×390 mm, to give a negative electrode plate. A non-aqueous electrolyte secondary battery was fabricated in the same manner as in Example 1, except that the negative electrode plate thus obtained was used.

### Example 5

Columns composed of the first portions 35 (oxygen content: 60% by mass), the second portions 36 (oxygen content: 8% by mass), and the third portions 37 (oxygen content: 30% by mass) were formed on the surfaces of protrusions 31 on the negative electrode current collector 21 in the same manner as in Example 1, except that the oxygen flow rate in forming the films 60 was changed to 1800 sccm, the oxygen flow rate in forming the films 61 was changed to 1200 sccm, and the oxygen flow rate in forming the films 62 was changed to 600 sccm, and thus a negative electrode was obtained. The negative electrode was cut in the size of 31 mm×390 mm, to give a negative electrode plate. A non-aqueous electrolyte secondary battery was fabricated in the same manner as in Example 1, except that the negative electrode plate thus obtained was used.

The oxygen contents in the first portions 35, the second portions 36, and the third portions 37 in the columns of Examples 1 to 5 are shown in Table 1 below.

TABLE 1

| | Oxygen content (% by mass) | | |
|---|---|---|---|
| | First portion | Second portion | Third portion |
| Example | 35 | 36 | 37 |
| 1 | 36 | 5 | 30 |
| 2 | 30 | 4 | 30 |
| 3 | 45 | 6 | 30 |
| 4 | 20 | 3 | 30 |
| 5 | 60 | 8 | 30 |

### Example 6

Columns composed of the first portions 35 (oxygen content: 36% by mass), the second portions 36 (oxygen content: 5% by mass), and the third portions 37 (oxygen content: 15% by mass) were formed on the surfaces of protrusions 31 on the negative electrode current collector 21 in the same manner as in Example 1, except that the oxygen flow rate in forming the films 70 was changed to 200 sccm, and the oxygen flow rate in forming the films 71 was changed to 400 sccm, and thus a negative electrode was obtained. The negative electrode was cut in the size of 31 mm×390 mm, to give a negative electrode plate. A non-aqueous electrolyte secondary battery was fabricated in the same manner as in Example 1, except that the negative electrode plate thus obtained was used.

### Example 7

Columns composed of the first portions 35 (oxygen content: 36% by mass), the second portions 36 (oxygen content: 5% by mass), and the third portions 37 (oxygen content: 45% by mass) were formed on the surfaces of protrusions 31 on the negative electrode current collector 21 in the same manner as in Example 1, except that the oxygen flow rate in forming the films 70 was changed to 600 sccm, and the oxygen flow rate in forming the films 71 was changed to 1200 sccm, and thus a negative electrode was obtained. The negative electrode was cut in the size of 31 mm×390 mm, to give a negative electrode plate. A non-aqueous electrolyte secondary battery was fabricated in the same manner as in Example 1, except that the negative electrode plate thus obtained was used.

### Example 8

Columns composed of the first portions 35 (oxygen content: 36% by mass), the second portions 36 (oxygen content: 5% by mass), and the third portions 37 (oxygen content: 15% by mass) were formed on the surfaces of protrusions 31 on the negative electrode current collector 21 in the same manner as in Example 1, except that the oxygen flow rate in forming the films 70 was changed to 300 sccm, and the oxygen flow rate in forming the films 71 was changed to 600 sccm, and thus a negative electrode was obtained. The negative electrode was cut in the size of 31 mm×390 mm, to give a negative electrode plate. A non-aqueous electrolyte secondary battery was fabricated in the same manner as in Example 1, except that the negative electrode plate thus obtained was used.

### Example 9

Columns composed of the first portions 35 (oxygen content: 36% by mass), the second portions 36 (oxygen content: 5% by mass), and the third portions 37 (oxygen content: 55% by mass) were formed on the surfaces of protrusions 31 on the negative electrode current collector 21 in the same manner as in Example 1, except that the oxygen flow rate in forming the films 70 was changed to 800 sccm, and the oxygen flow rate in forming the films 71 was changed to 1400 sccm, and thus a negative electrode was obtained. The negative electrode was cut in the size of 31 mm×390 mm, to give a negative electrode plate. A non-aqueous electrolyte secondary battery was fabricated in the same manner as in Example 1, except that the negative electrode plate thus obtained was used.

The oxygen contents in the first portions 35, the second portions 36, and the third portions 37 in the columns of Examples 6 to 9 are shown in Table 2 below.

TABLE 2

| | Oxygen content (% by mass) | | |
|---|---|---|---|
| | First portion | Second portion | Third portion |
| Example | 35 | 36 | 37 |
| 6 | 36 | 5 | 15 |
| 7 | 36 | 5 | 45 |
| 8 | 36 | 5 | 8 |
| 9 | 36 | 5 | 55 |

### Comparative Example 1

A negative electrode was produced in the same manner as in Example 1, except that, in forming a negative electrode active material layer, the oxygen flow rate during the formation of the first portions was not decreased and kept constant at 720 sccm, and the oxygen flow rate during the formation of the third portions was not increased and kept constant at 600 sccm. The first portions of the columns were composed of a silicon oxide represented by SiO_{1.0}. The second portions were mainly composed of silicon, and the oxygen content in the second portions as a whole was 5% by mass. The third portions were composed of a silicon oxide represented by SiO_{0.75}.

A non-aqueous electrolyte secondary battery was fabricated in the same manner as in Example 1, except that the negative electrode thus obtained was used.

### Comparative Example 2

A negative electrode was produced in the same manner as in Example 1, except that, in forming a negative electrode active material layer, the oxygen flow rates during the formation of the first to third portions were kept constant at 500 sccm. The columns were composed of a silicon oxide represented by SiO_{0.6}. A non-aqueous electrolyte secondary battery was fabricated in the same manner as in Example 1, except that the negative electrode thus obtained was used.

### Comparative Example 3

A negative electrode was produced in the same manner as in Example 1, except that, in forming a negative electrode active material layer, no oxygen was supplied during the formation of the first to third portions. The columns were mainly composed of silicon, and the oxygen content in the columns was 5% by mass. A non-aqueous electrolyte secondary battery was fabricated in the same manner as in Example 1, except that the negative electrode thus obtained was used.

The non-aqueous electrolyte secondary batteries fabricated in Examples 1 to 9 and Comparative Examples 1 to 3 were evaluated for the following items. The evaluation results are shown in Table 3.

### [Battery Capacity]

The non-aqueous electrolyte secondary batteries of Examples 1 to 9 and Comparative Examples 1 to 3 were subjected to three charge/discharge cycles in a 20° C. environment, each cycle consisting sequentially of a constant current charge (charge current: 0.7 C, end-of-charge voltage: 4.15 V), a constant voltage charge (charge voltage: 4.15 V, end-of-charge current: 0.05 C), an interval for 20 minutes during which the batteries were allowed to stand, a constant current discharge (discharge current: 0.2 C, end-of-discharge voltage: 2.0 V), and an interval for 20 minutes during which the batteries were allowed to stand. The discharge capacity of each battery at the end of the 3rd cycle (defined as the “0.2 C capacity”) was measured. Here, it was predicted that the battery capacities of the non-aqueous electrolyte secondary batteries of Examples 1 to 9 and Comparative Examples 1 to 3 would be almost the same, since these batteries were designed such that the battery capacity is determined depending on the positive electrode capacity.

### [Rate Characteristic]

The non-aqueous electrolyte secondary batteries of Examples 1 to 9 and Comparative Examples 1 to 3 were sequentially subjected to, in a 20° C. environment, a constant current charge (charge current: 0.7 C, end-of-charge voltage: 4.15 V), a constant voltage charge (charge voltage: 4.15 V, end-of-charge current: 0.05 C), and a constant current discharge (discharge current: 1.0 C, end-of-discharge voltage: 2.0 V). The discharge capacity of each battery at the end of the constant current discharge was defined as the “1 C capacity”. The ratio of the 1 C capacity to the 0.2 C capacity obtained in the above battery capacity evaluation was calculated as a percentage, which was defined as a rate characteristic (%). A higher rate characteristic means a capability of providing a higher output. It should be noted that the battery of Comparative Example 3 failed to function as a battery in the course of the above constant current charge, constant voltage charge, and constant current discharge for evaluating the rate characteristic, and the measurement of the rate characteristic thereof was impossible.

### [Cycle Characteristic]

The non-aqueous electrolyte secondary batteries of Examples 1 to 9 and Comparative Examples 1 to 3 were subjected to one hundred charge/discharge cycles. In the 1st and 100th charge/discharge cycles, each battery was sequentially subjected to, in a 20° C. environment, a constant current charge (charge current: 0.7 C, end-of-charge voltage: 4.15 V), a constant voltage charge (charge voltage: 4.15 V, end-of-charge current: 0.05 C), and a constant current discharge (discharge current: 0.2 C, end-of-discharge voltage: 2.0 V). The 2nd to 99th charge/discharge cycles were performed under the same conditions as those in the 1st cycle, except that the discharge current in the constant current discharge was changed from 0.2 C to 1 C. The ratio of the discharge capacity at the 100th cycle to the discharge capacity at the 1st cycle was calculated as a percentage, which was defined as a capacity retention rate (%).

It should be noted that, with regard to the battery of Comparative Example 2, the discharge capacity after three cycles was reduced to be 10% of the initial discharge capacity, and the evaluation was terminated at this point. With regard to the battery of Comparative Example 3, the battery became incapable of being charged and discharged after three cycles. This is presumably because most of the negative electrode active material layer was separated from the negative electrode current collector due to the changes in volume (expansion and contraction) of the alloy-based active material associated with repeated charging and discharging.

### [Battery Swelling]

In the evaluation for the cycle characteristic, the thicknesses of the electrode assembly before the evaluation and after the evaluation (after 100 cycles) were measured, and the ratio of the thickness of the electrode assembly after the evaluation to the thickness of the electrode assembly before the evaluation was calculated as a percentage, which was defined as a rate of battery swelling. A larger rate of battery swelling means a larger swelling of the electrode assembly. Here, the battery swelling rates of the batteries of Comparative Examples 2 and 3 are the values after three cycles in the cycle characteristic evaluation. The results are shown in Table 3.

TABLE 3

| | | | Capacity | |
|---|---|---|---|---|
| | Discharge | Rate | retention | Battery |
| | capacity | characteristic | rate | swelling |
| | (mAh) | (%) | (%) | (%) |
| Example 1 | 7.5 | 98 | 90 | 101 |
| Example 2 | 7.6 | 98 | 88 | 101 |
| Example 3 | 7.3 | 98 | 92 | 101 |
| Example 4 | 8.0 | 98 | 80 | 101 |
| Example 5 | 6.9 | 98 | 90 | 105 |
| Example 6 | 7.6 | 98 | 87 | 101 |
| Example 7 | 7.4 | 98 | 90 | 101 |
| Example 8 | 7.8 | 99 | 85 | 104 |
| Example 9 | 6.9 | 92 | 90 | 101 |
| Comparative | 7.5 | 95 | 70 | 101 |
| Example 1 | | | | |
| Comparative | 6.9 | 90 | 10 | 101 |
| Example 2 | | | | |
| Comparative | 1.2 | x | x | 102 |
| Example 3 | | | | |

As is evident from Table 3, the batteries of Examples 1 to 9, in particular, the batteries of Examples 1 to 3 and 6 to 7, exhibited discharge capacities that were kept high even when the number of charge/discharge cycles was increased, and were excellent in cycle characteristics. The batteries of Examples 1 to 9, in particular, the batteries of Examples 1 to 3 and 6 to 7, are excellent in rate characteristic and capable of providing high output, and therefore, are suitably applicable as a power source not only for electronic equipment but also for transportation equipment such as electric vehicles. The batteries of Examples 1 to 9, in particular, the batteries of Examples 1 to 3 and 6 to 7, exhibited almost no battery swelling even after one hundred cycles, indicating that, in the interior of these batteries, the changes in volume of the alloy-based active material are reduced, and the occurrence of the side reaction with the non-aqueous electrolyte, the deformation of the negative electrode, and the like are suppressed.

In contrast, with regard to the rate characteristic and the battery swelling, the battery of Comparative Example 1 exhibited the same level as the battery of Example 1, but a lower capacity retention rate than that of the battery of Example 1. This is presumably because the first portion and third portion having a gradient of oxygen concentration were not formed in the negative electrode active material layer, and this resulted in the occurrence of a separation of the negative electrode active material layer from the negative electrode current collector, although the degree of separation was small as compared to in Comparative Examples 2 and 3. The battery of Comparative Example 2 exhibited a significant reduction in the discharge capacity at the 3rd charge/discharge cycle. The battery of Comparative Example 3 failed to function as a battery at the 3rd charge/discharge cycle.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A negative electrode for a non-aqueous electrolyte secondary battery comprising: a current collector; and an active material layer being supported on the current collector and comprising at least two alloy-based active materials selected from the group consisting of silicon, tin, a silicon oxide, and a tin oxide, wherein:
the active material layer includes a first portion supported on a surface of the current collector, a second portion supported on a surface of the first portion, and a third portion supported on a surface of the second portion;
the first portion includes the silicon oxide or the tin oxide, and an oxygen content in the silicon oxide or the tin oxide in the first portion decreases continuously or stepwise as approaching the second portion;
the second portion includes silicon or tin; and
the third portion includes the silicon oxide or the tin oxide, and an oxygen content in the silicon oxide or the tin oxide in the third portion increases continuously or stepwise with distance from the second portion.

2. The negative electrode for a non-aqueous electrolyte secondary battery according to claim 1, wherein the active material layer includes a plurality of columns comprising the at least two alloy-based active materials, the columns being spaced apart from one another and extending outward from the surface of the current collector, and each having the first portion, the second portion, and the third portion.

3. The negative electrode for a non-aqueous electrolyte secondary battery according to claim 2, wherein the current collector has a plurality of protrusions on the surface thereof, and the columns are supported on surfaces of the protrusions.

4. The negative electrode for a non-aqueous electrolyte secondary battery according to claim 1, wherein the first portion has an oxygen content of 25% by mass to 50% by mass.

5. The negative electrode for a non-aqueous electrolyte secondary battery according to claim 1, wherein the second portion includes oxygen as an inevitable impurity in addition to the silicon or the tin, and has an oxygen content of 1% by mass to 25% by mass.

6. The negative electrode for a non-aqueous electrolyte secondary battery according to claim 1, wherein the third portion has an oxygen content of 10% by mass to 50% by mass.

7. The negative electrode for a non-aqueous electrolyte secondary battery according to claim 1, wherein the first portion is a stack of films including the silicon oxide or the tin oxide, and the difference in the oxygen content in the silicon oxide or the tin oxide between two of the films adjacent to each other is 10% by mass to 45% by mass.

8. The negative electrode for a non-aqueous electrolyte secondary battery according to claim 1, wherein the third portion is a stack of films including the silicon oxide or the tin oxide, and the difference in the oxygen content in the silicon oxide or the tin oxide between two of the films adjacent to each other is 10% by mass to 45% by mass.

9. The negative electrode for a non-aqueous electrolyte secondary battery according to claim 1, wherein the first portion includes the silicon oxide, the second portion includes silicon, and the third portion includes the silicon oxide.

10. The negative electrode for a non-aqueous electrolyte secondary battery according to claim 1, wherein the first portion includes a region including the silicon oxide or the tin oxide, and an oxygen content in the silicon oxide or the tin oxide in the region increases continuously or stepwise as approaching the second portion.

11. The negative electrode for a non-aqueous electrolyte secondary battery according to claim 1, wherein the third portion includes a region including the silicon oxide or the tin oxide, and an oxygen content in the silicon oxide or the tin oxide in the region decreases continuously or stepwise with distance from the second portion.

12. A non-aqueous electrolyte secondary battery comprising a positive electrode capable of absorbing and desorbing lithium ions, a negative electrode capable of absorbing and desorbing lithium ions, a separator interposed between the positive electrode and the negative electrode, and a non-aqueous electrolyte,
wherein the negative electrode is the negative electrode for a non-aqueous electrolyte secondary battery of claim 1.
